(19) United States
(12) Patent Application Publication
(10) Pub. No.: US 2025/0344690 A1
(43) Pub. Date: Nov. 13, 2025

(54) WATERFOWL DECOY APPARATUS AND METHOD

(71) Applicant: Christopher Loria, Orono, MN (US)

(72) Inventor: Christopher Loria, Orono, MN (US)

(21) Appl. No.: 18/660,861

(22) Filed: May 10, 2024

(51) Int. Cl. A01M 31/06

(52) U.S. Cl. CPC A01M 31/06

(57) ABSTRACT

A subscale waterfowl decoy device including a subscale body having a length in the range of 0.25 L to 0.85 L, where L is the length of a full-sized waterfowl. The subscale waterfowl decoy includes a pair of subscale waterfowl wings attached to the body, a subscale waterfowl head attached to the subscale body. The subscale body made of a buoyant material, or other material.

### TECHNICAL FIELD

The subject matter disclosed herein relates to waterfowl decoys on land or water and, in particular, to forming and placing waterfowl decoys to bring waterfowl in closer proximity to a hunter, photographer, naturalist or the like while out in the field.

### BACKGROUND

Waterfowl hunters and others have long recognized that waterfowl as prey animals are attracted to areas that appear to be inhabited by similar wildlife. For this reason, hunters, photographers, and others have long used decoys to attract live waterfowl to within shooting or viewing distance. Furthermore, larger waterfowl decoy spreads, on land or water are more effective at decoying in birds because the waterfowl have learned there is safety in numbers.

For many years now, larger than life-size waterfowl decoys or “magnum” decoys have been marketed to waterfowl hunters. The marketing typically describes how these larger-than-life decoys will be more visible to waterfowl, such as ducks and geese. These magnum decoys for a Mallard duck are typically 20.75″ (52.70 cm) in length, and weigh approximately 40.5 oz. A life-sized Mallard duck decoy is 16″ (40.64 cm) long, and weighs 31.7 oz. Based on the theory that the larger decoys are more visible to waterfowl; manufacturers now even produce super magnum decoys which are around 26″ (66.04 cm) in length.

### SUMMARY

According to one aspect, a subscale waterfowl decoy device including a subscale body having a length in the range of 0.25 l to 0.85 l, where l is the length of a full-sized waterfowl. The subscale waterfowl decoy includes a pair of subscale waterfowl wings attached to the body; a subscale waterfowl head attached to the subscale body. The subscale body is made of a buoyant material. The subscale waterfowl decoy also includes a weight system attached to the waterfowl body.

According to another aspect, a plurality of subscale waterfowl decoy devices grouped together as a set, at least some of the plurality of subscale waterfowl decoy devices have a subscale body having a length in the range of 0.25 l to 0.85 l, where l is the length of a full-sized waterfowl.

According to still another aspect, a kit includes a plurality of subscale waterfowl decoy devices, at least some of the plurality of subscale waterfowl decoy devices having a subscale body having a length in the range of 0.25 l to 0.85 l, where l is the length of a full sized waterfowl, a pair of subscale waterfowl wings attached to the body, and a subscale waterfowl head attached to the subscale body, at least the subscale body made of a buoyant material the subscale waterfowl decoy devices also include a weight system attached to the waterfowl body, an anchor ring positioned on an underside of the waterfowl body, and a set of anchor lines for the plurality of subscale waterfowl decoy devices.

### BRIEF DESCRIPTION OF THE DRAWINGS

FIG. 1 is a is a schematic plan view of blind and decoy spread, according to prior art.

FIG. 2 is a schematic plan view of blind and decoy spread, using subscale decoys, according to an example embodiment.

FIG. 3 is a schematic plan view of blind and a decoy spread, using subscale decoys, comprised of two decoy spreads, according to an example embodiment.

FIG. 4 is a schematic plan view of blind and decoy spread, according to another example embodiment.

FIG. 5 shows a series side views of various sized waterfowl decoys having representative sizes.

FIG. 6 shows the decoy having a weight and decoy line attachment system attached to the belly of the decoy, according to one embodiment.

FIG. 7 shows a top view of the weight and decoy line attachment system separated from a decoy, according to an embodiment.

FIG. 8 is a side view of the weight and decoy line attachment system separated from a decoy, according to an embodiment.

FIG. 9 shows a front view of the decoy, according to another embodiment.

FIG. 10 is a top view of the decoy, according still another embodiment.

### DETAILED DESCRIPTION

The present disclosure describes, a subscale waterfowl decoy device including a subscale body having a length and/or volume in the range of 0.25 L to 0.85 L, where L is the length (or volume) of a full-sized waterfowl, placement of a plurality of subscale waterfowl decoys, and kits that include subscale decoys, weighting systems, anchor weights and anchor lines. Length will be generally described, but volume can be used as an alternative measure.

To come up with this approach, the inventor needed the experiences and knowledge from being a test pilot and Astronaut, as well as working with scientists and biologists in a research setting. His vast and broad experiences as a test pilot and Astronaut, with 26 years of aviation safety training briefings, and mishap reports is how/where he gained the insight regarding size constancy for runways. From his experiences as a hunter for 30+ years, he personally observed waterfowl flying away at greater distances when magnum (oversized) waterfowl decoys were used.

During his career he consulted for the National Science Foundation (NSF), and was the Observatory Director for the National Science Foundation's National Ecological Observatory Network (NEON) in Boulder, Colorado. During those fairly unique experiences he learned from the staff scientists and biologists just how remarkable waterfowl vision is.

By putting all three things together (size constancy for approach and landing, waterfowl behavior with magnum sized decoys and the remarkable visual acuity of waterfowl) he discovered the embodiments herein.

Waterfowl vision is remarkable. Waterfowl have visual acuity that far surpasses that of humans. Compared to waterfowl, humans have tunnel vision and have a nearsighted, blurred view of the world. Waterfowl have a highly specialized retina that enables them to have better distance visions and finer vision at distances up to two to three times that of humans.

A human eye is essentially spherical shaped, whereas a waterfowl eye is more flattened. With that more flattened shape the waterfowl eye serves as a super wide-angle lens, capturing a wide field of vision. This amazing structure allows waterfowl in one glance to see close and distant objects in sharp focus.

The refractive power of the waterfowl eye is unlike other animals. In waterfowl, the refractive power of both the cornea and the lens is increased by the contraction of two powerful eye muscles allowing waterfowl to better control the curvature of both. In contrast, people can affect only the curvature of the lens. Remarkably, this ability of waterfowl to control the curvature of both their cornea and lens enables waterfowl to see extremely well while flying and/or while diving/feeding. For example, diving ducks can see the same refractive index as water, resulting in filtering of interference and allowing for a clear view below the surface.

Additionally, waterfowl have one of the most highly developed, complex retinas in nature, and one of the most capable of any animal under daylight conditions. This visual acuity is enabled by the large number of color-receptive cones within the eye, with up to five times as many cone cells (color receptors) than humans. This allows waterfowl to form sharp images regardless of where the light strikes the retinal wall. The double cones aid in movement detection, and single cones are responsible for wavelength discrimination.

The spectral sensitivity of major cone types within the retina are measured based on the optical density of the anterior half of the eye as well as with the visual pigment and oil droplet combinations within the intact cones. Visual pigments and oil droplets form six classes of photoreceptors in the retinas of birds. Oil droplets of bird eyes act like microlenses which serve as spectral filters. The red and yellow oil droplets enable better distance vision and provide finer vision up to two to three times further than in humans.

The incredible waterfowl visual acuity is also a function of the high concentration of blood vessels concentrated in a single retinal structure (pecten), as contrasted with humans where the blood vessels are present throughout the retina. This minimizes interference and provides a greater sensitivity of motion. The pecten acts both as a central retinal artery in the eye, thus protecting it from ultraviolet (UV) light as well as supplying oxygen to the retina, pressure regulation, pH regulation, and reducing glare. At higher waterfowl flying altitudes, the melanin content of the pecten is believed to increase the temperature of the eye, enabling more optimal physiology at those higher and colder altitudes.

The pecten structure in waterfowl retinas minimizes light frequency interference within the waterfowl eye and provides a great sensitivity and to motion and the ability to detect motion. Retina blood flow capabilities and waterfowl tetra-chromatic vision (from single cones, dual cones, and refractive oil droplets in their cones) enable waterfowl to have greater visual acuity from altitude and during dawn and dusk.

Avian vision is highly developed because of the highly developed avian retina. In daylight, it is the most capable of any animal. A large number of color-receptive cones within the eye allow birds to form sharp images regardless of where light strikes the retinal wall. Additionally, blood vessels in the avian eye are concentrated in a single retinal structure, known as the pecten, as opposed to being embedded throughout the retina as in the human eye. This offers less visual interference and provides greater sensitivity to motion. The structure of the eye in waterfowl allows the birds to see objects in fine detail two and a half to three times farther away than a human's eye.

Waterfowl, and birds in general, are able to depict the colors red, yellow and blue with clarity and with much more vibrancy than humans. In addition, due to an extra set of photoreceptor cones specifically designed to capture UV radiation, they have increased sensitivity to light-which results in waterfowl having tetra-chromatic vision. Birds have UV-sensitive (UVS) visual pigments with sensitivity maxima around 360-373 nm (UVS) or 402-426 nm (violet-sensitive, VS). This is particularly useful for waterfowl as the percentage of UV light is highest at dawn and dusk.

With such remarkable visual acuity and visual capability, waterfowl can easily see decoys that are normal sized, magnum-sized, and super magnum-sized with little effort.

What has been now discovered is that the bigger the decoy, the farther away from a decoy flock or spread the actual waterfowl flares and lands. For example, when normal sized decoys are used, the waterfowl flares out (puts it wings in a position where it is losing lift) and lands at a distance X, and when a magnum decoy is used the waterfowl flares earlier and lands further from the decoy flock or spread such as at a distance X+Y. Furthermore, when a bigger sized decoy, such as a super magnum decoy, is used in forming a flock or spread on land or water, the waterfowl flares out even earlier and lands farther away from the flock of spread at a distance X+Y+Z.

Making larger decoys has been the trend for many years. Now, even some blinds that house a hunter have been made into decoys. This trend has many effects. Bigger decoys weigh more and need more weight along the keel to stabilize the decoy if in water. Bigger weights are needed to anchor the decoys. More area is needed to make a spread or grouping of decoys. Birds are most vulnerable when they spread their wings and land. The bird is slowest and easier to shoot during the flare portion of landing. When birds land farther away, more birds are just wounded rather than cleanly killed. Fewer shots, or longer less optimal shots, result in more wounded birds that fly away only to later succumb to their wounds.

A shotgun is used to hunt waterfowl. The farther the propelled shot travels the more kinetic energy the shot loses. Shots at longer distances are not as effective as shorter distance shots. The shot or pellets lose kinetic energy the farther they travel. To combat this, bigger powder loads are used in shot gun shells so the hunter can “reach out” to the waterfowl. Bigger loads and more shot also produce higher recoil or kick that the hunter must endure. Bigger shotguns capable of holding longer shells are needed to handle magnum loads. These bigger guns are heavier which further taxes the hunter.

The surprising solution is to form sub-scale waterfowl decoys. In other words, decoys that are smaller than the life size decoys are produced and laid out in smaller spreads with larger numbers in flocks for ducks and geese. The smaller decoys weigh less. The amount of weight needed to stabilize the decoy is reduced, requiring less anchor weight. Smaller decoys do not take up as much space when transporting the decoys to the set-up area. If the same weight is transported, the hunter has more decoys to deploy into one or more spreads or flocks of decoys. Waterfowl have learned that larger numbers in a flock generally mean more safety, therefore larger numbers of decoys in each spread imply safety and are more effective at decoying waterfowl. The smaller decoys also draw the birds in closer to the spread, so hunters no longer need magnum loads to “reach out” to the birds. If they land closer to a spread in front of a blind, the shots are not as long. Magnum loads and guns are not needed. The closer range makes hunters or photographers more effective. If hunting, fewer birds are wounded for a selected limit harvested.

With waterfowl vision documented as 2-3 times better than humans, sub-scale waterfowl decoys will be readily seen by waterfowl. The sub-scale waterfowl decoys, in one embodiment, will use ultraviolet (“UV”) paint, such as paint tailored to the UV vision capabilities of waterfowl. In this manner, waterfowl will also be able to more easily see the decoys. Of course, it is contemplated that other paints could be used to paint a waterfowl decoy.

Approach and landing are the most demanding phases of flight and accordingly, where mistakes (pilot error) can, and frequently do, occur. The most common, if not one of the top visual illusions during approach and landing for pilots, across the globe, is relative size of the runway or landing environment. This is also referred to as size constancy. Waterfowl base their landings on the point of reference that is most available to them which is the size of the waterfowl they are landing next to. The birds begin their flair maneuver based on their perceived height and distance above the landing area. The perceived height and distance is gauged by the size of the waterfowl or decoys they are landing near. The size of the waterfowl in a spread of decoys is the visual que which the landing bird uses. It should be noted that many waterfowl spreads will be in open water where other size cues for the waterfowl are not in close proximity. Even near the shore or trees, waterfowl attention will be focused on the decoys and will fly closer and lower than normal to the sub-scale decoys. Waterfowl also commonly land in fields where there generally are no other objects to gauge perceived height on other than the decoys.

Most of the time, waterfowl land near live birds which are life size or true size. The waterfowl do this repeatedly. Like a human pilot, they use points of reference to determine when to flair out and land during an approach. For humans, most of the time it is the width of the runway. If you land most of the time on one size runway, the pilot learns when to flair on a feature such as the width of the runway. When a runway is wider than what the pilot is used to, the pilots will tend to flair out early and higher than normal and before the runway threshold. When pilots make an approach on a narrower runway than one they are most used to, the width of the runway does not appear right until they are closer to the ground, so pilots tend to flair late and land late or closer to the threshold of the runway. What has been found is that waterfowl have no reference point like the width of a runway. Rather, the waterfowl's reference point is the size of the bird or birds that it is landing near. Hence, for a bigger bird, it “looks right” farther away from the set or grouping of magnum decoy and the birds flare further away, land earlier and farther away from the decoys. With a group or set up of smaller decoys the birds do not look to be the right size until the waterfowl is closer into the set-up of smaller or sub-scale decoys. This will result in the waterfowl flying closer into the decoys, flaring late, and landing in closer to the decoys.

Subscale waterfowl decoys can be used on land or water to attract waterfowl to a selected position. Subscale decoys means that the decoys are less than life-sized, or less than full scale. As depicted below for a species of duck called the mallard, full scale mallards are about 16″ (40.64 cm) in length. Subscale is a decoy, such as a duck decoy that is smaller than a full scale or full-sized waterfowl. Below is a table illustrating this concept with a mallard duck decoy. Of course, other waterfowl will have different full size or full-scale size. Most ducks will have approximately the same full-scale size as a mallard. However, there can be ducks that are smaller when full sized. It should also be understood that a goose is also a waterfowl. A full sized or full-scale goose is much larger than a duck or a mallard duck. So, this concept is based on full-scale or full-size waterfowl. For the sake of conversation, a mallard duck decoy will be discussed as this is a popular decoy that is used. It should be noted that this concept is applicable to any sized waterfowl which are attracted to land with decoys.

The normal mallard duck has a length of approximately 16″ (inches) in length. Therefore, a normal sized decoy has approximately the same length dimension. Of course, a decoy has similar features to a normal duck or waterfowl that it is replicating. When a sub-scale duck is made, the similar features are reduced by the same amount. For example, a 12″ (inch) (30.48 cm) duck is 75% of the size of the normal duck or normal duck decoy. All features will be reduced by 25% (wings, head size, neck size, eyes, and the like) so that the entire decoy has all features that are all 75% of the normal duck or normal duck decoy.

| | | |
|---|---|---|
| Normal Size Decoy (Full scale) | 16″ | (40.64 cm) |
| ¾ Normal Size (Subscale) | 12″ | (30.48 cm) |
| ½ Normal Size (Subscale) | 6″ | (15.24 cm) |

The above table is just a sampling of the possible decoy sizes. It is contemplated that in some embodiments, the size of the decoy can range from 25% to 85% of the size of a normal decoy. In other embodiments, the size of the decoy can range from 35% to 80% of the size of a normal decoy. In still further embodiments, the size of the decoy can range from 45% to 75% of the size of a normal decoy. In yet another embodiment, the size of the decoy can range from 50% to 65% of the size of a normal decoy. The length of the decoy can be used as an indication of the scale of the decoy.

Generally, subscale waterfowl decoys are placed in a group called a set so that the birds see a number of waterfowl in a spread area which conveys safety to the incoming waterfowl. Such a set can be used on land or water to attract waterfowl to a selected position.

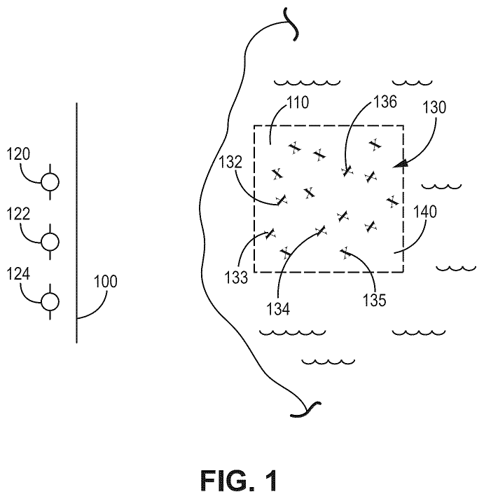

FIG. 1 is a schematic plan view of blind 100 and decoy spread 110, according to prior art. The blind 100 is depicted by a line. Behind the blind 100 are three observers or hunters 120, 122, 124. The blind 100 generally obscures the observers or hunters 120,122, 124 from waterfowl approaching a decoy spread 110. The blind 100 can be camouflaged so that it blends into the surroundings near the blind 100. The spread 110 is generally a grouping 130 of decoys 132, 133, 134, 135, 136 within an area 140 (depicted as within a square 141 with dotted lines to indicate invisibility). The grouping 130 of decoys 132, 133, 134, 135, 136 is depicted by a number of X's in the area 140. As shown in FIG. 1, fifteen full-scale or full size or life size decoys 132, 133, 134, 135, 136 are spread across the area 140.

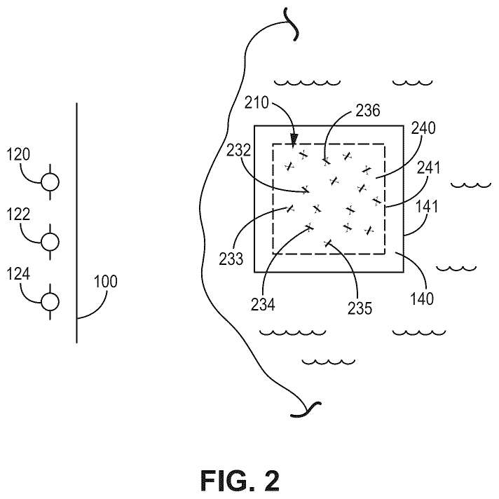

FIG. 2 is a schematic plan view of blind and decoy spread 200, according to an example embodiment. The blind 100 is depicted by a line. Behind the blind 100 are three observers or hunters 120, 122, 124. The blind 100 generally obscures the observers or hunters 120,122, 124 from waterfowl approaching a decoy spread 210. The blind 100 can be camouflaged so that it blends into the surroundings near the blind 100. The spread 210 is generally a grouping 230 of decoys 232, 233, 234, 235, 236 within an area 240 (depicted as within a square 241 with dotted lines to indicate invisibility). The grouping 230 of decoys 232, 233, 234, 235, 236 is depicted by a number of X's in the area 240. As shown in FIG. 2, fifteen sub-scale or less than full size or less than life size decoys 232, 233, 234, 235, 236 are spread across the area 240. As shown, the ducks are ¾ size or 75% of the size of a full size or life size decoy. The same number of decoys 232, 233, 234, 235, 236 are spread across a smaller area 240. In FIG. 2, the area 140 is now shown as being bounded by a solid black line. Area 240 is also 75% smaller than the area 140 from FIG. 1. The advantage is that the hunter or observers can set the spread more quickly and over a smaller area than when full sized decoys are used. Additional advantages are that the decoys 232, 233, 234, 235, 236 will be more compact and weigh less than the full-size decoys 132, 133, 134, 135, 136. Decoys set in water have anchor weights which will be less for the decoys 232, 233, 234, 235, 236 when compared to the decoys 132, 133, 134, 135, 136. Additionally, the decoys 232, 233, 234, 235, 236 will have less weight within the decoys 132, 133, 134, 135, 136. The hunter or observers can set these up over a smaller area and have to transport a less bulky decoy. Creating the set can also be done more efficiently as the set is placed over a smaller area. Another advantage for the person using subscale decoys is that for the same, or comparable weight and bulk of decoys compared to life sized or magnum decoys, a larger number of subscale decoys can be used which looks safer to waterfowl and will increase the effectiveness of the decoy spread.

These advantages will be more pronounced when making a set of subscale decoys 232, 233, 234, 235, 236 is compared to making a set of magnum decoys or super magnum decoys.

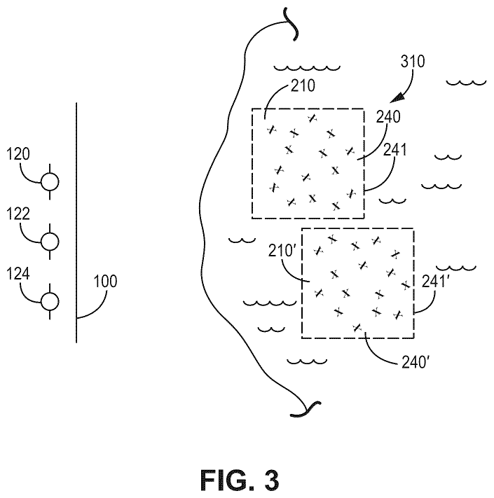

FIG. 3 is a schematic plan view of blind 100 and a decoy spread 310 comprised of two decoy spreads 210 and 210′, according to an example embodiment. The decoy spreads 210 and 210′ are substantially the same as the decoy spread 210 in FIG. 2. This simply illustrates that by using subscale decoys more decoys can be deployed to form a larger spread. The decoys in the spread 310 are all 75% of the size of a full sized or life-sized decoy.

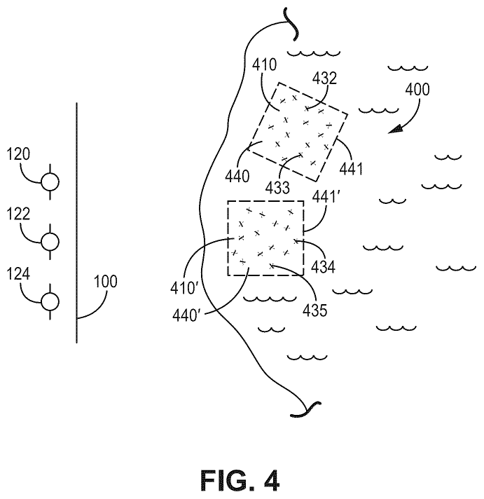

FIG. 4 is a schematic plan view of blind and decoy spread 400, according to an example embodiment. In this embodiment, the decoys 432, 433, 434, 435, 436 are subscale decoys that are 50% of the size of the full sized decoys 132, 133, 134, 135, 136 shown in FIG. 1. The smaller decoys 432, 433, 434, 435, 436 can be distributed over two areas 440 and 440′ that, when combined, are the same size as the area 140 shown in FIG. 1. The two areas 440 and 440′ equal the area over which the full size or full-scale decoys 132, 133, 134, 135, 136 are spread as shown in FIG. 1. The spread 400 can also be thought of as two smaller spreads 410 and 410′. The areas are bounded by invisible boxes depicted as dashed lines 441 and 441′.

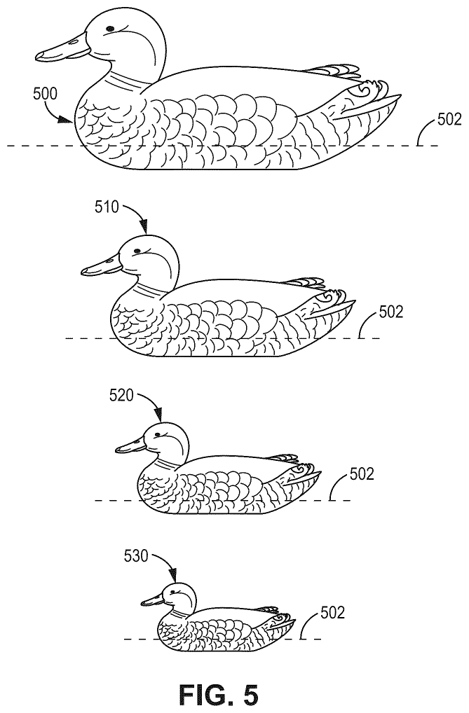

FIG. 5 shows a series of side views of various sized decoys having representative sizes. Shown in FIG. 5 is a side view of a decoy representative magnum mallard decoy 500, a side view of a representative life-sized mallard decoy 510, a side view of a representative 75% sub-scale mallard decoy 520, and a side view of a representative 50% sub-scale mallard decoy 530. The magnum sized decoy 500 and the life-sized decoy 510 are prior art. The representative 75% sub-scale Mallard decoy 520, and a representative 50% sub-scale mallard decoy 530, are alternate decoy embodiments of the present disclosure. Waterfowl decoy embodiments will include other duck and goose species and is not limited to the embodiments of sub-scale mallard duck. It should be noted that in each series of side views there is a broken line that is indicative of the waterline 502 for the particular sized decoy. The hardware that is on the bottom of each decoy will be discussed in the following FIGs.

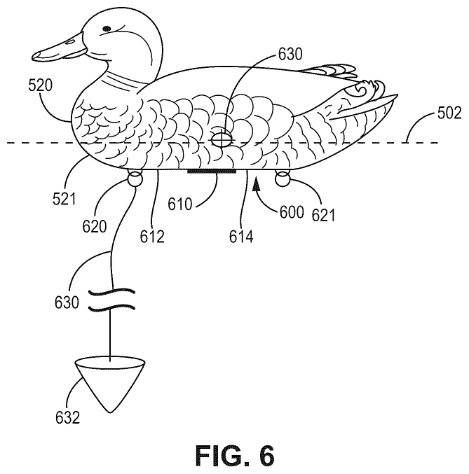

FIG. 6 shows the decoy 520 having a weight and decoy line attachment system 600 attached to the belly 521 of the decoy 520, according to one embodiment. The weight and decoy line attachment system 600 is attached to the decoy 520 below the waterline 502 so that it is invisible to other waterfowl. The weight and decoy line attachment system 600 includes a weight 610. The weight 610 is attached so that the center of the weight 610 is below the center of gravity 630 of the decoy 520. In this way, the decoy 520 will not tilt to the right or the left nor will it tilt forward or ride high on one end verses the other end. The weight is sufficient to bring the center of gravity 630 near to the waterline 502 which assures that the decoy 520 will be stable in the water. The decoy 520 can be made of any number of materials less dense that water, or hollow, so that it floats. The decoy can also be formed with air pockets to allow it to float more or produce a force of buoyancy. The weight will be sized to counteract the force of buoyancy and move the center of gravity to a point near the waterline 502.

Attached to the weight 610 is a first finger 612 and a second finger 614. Attached to the first finger 612 is a first ring 620. Attached to the second finger 614 is a second ring 621. The rings 620 and 621 are sized to receive an anchor line 630. The anchor line 630 is used to prevent the drifting away with the wind or current of the decoy 520. As shown, the anchor line 630 is attached at one end to ring 620 and at the other end to a weight 632. Only a single anchor line 630 is shown in FIG. 6. It should be understood that the ring 621 might also use a single anchor line (not shown) or that two anchor lines could be attached to ring 620 and to ring 621. Weights, such as weight 632 are generally used as anchors.

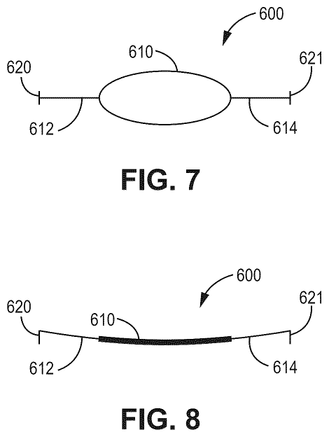

FIG. 7 shows a top view of the weight and decoy line attachment system 600 separated from a decoy, according to an embodiment. In this particular embodiment, the weight 610 has an oval shape sized to fit the belly of the decoy 520. The weight is generally made of generally environmentally friendly metals such as stainless steel or a coated metal such as iron to halt or slow rust. The size of the weight 610 counters the force of buoyancy. Attached to the weight 610 is a first finger 612 and a second finger 614. Attached to the first finger 612 is a first ring 620. Attached to the second finger 614 is a second ring 621. The rings 620 and 621 are sized to receive an anchor line 630.

FIG. 8 is a side view of the weight and decoy line attachment system 600 separated from a decoy, according to an embodiment. It shows that the weight and decoy line attachment system 600 is gently bowed from one ring 620 to the other ring 612. The first finger 612 and the second finger 614 are attached to the weight 610. At the distal end of the first finger 612 is the ring 620. At the distal end of the second finger 614 is the ring 621. It is contemplated that the weight and decoy line attachment system 600 could be made with different sized weights for use with various decoys. The weight and decoy line attachment system 600 could then be transferred from decoy to decoy as the decoys wear. In other instances, different weights could be made for different breeds of waterfowl.

The decoy 520 or any of those decoys shown in FIG. 5 could also be used on land. Generally, weight and decoy line attachment system 600 could be removed from these decoys. The decoys could rest on land. In one embodiment, a spike could be used to hold the decoy with respect to the ground. In other embodiments, especially where the ground may be frozen in a late season hunt, the decoys could be weighted and other otherwise attached to the ground.

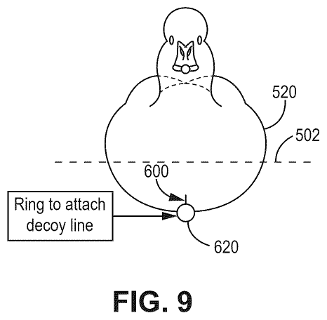

FIG. 9 shows a front view of the decoy 520, according to another embodiment. In this embodiment, the attachment ring 620 is slightly recessed into the body. The weight and decoy line attachment system 600 in this embodiment could be encased in the material of the decoy 520 so that the weight and decoy line attachment system 600 would generally detach from the decoy 520. Such a decoy would be made so as to never come apart as it were. Decoys may be made using additive manufacturing, and or injection molding, other manufacturing processes explored and could be utilized as well. Materials for decoy manufacture include and are not limited to polyethylene vinal acetate or PEVA, also called EVA which is a material similar to what is used in manufacturing footwear. Other materials include, and are not limited to, high density polyethylene (HDPE) and low-density polyethylene (LDPE). The decoy may be a single piece (head, wings, body, etc.) or made in multiple attachable components.

The submerged portion of the decoys will have a complex, curved surface somewhat mimicking the submerged species of waterfowl being presented. Curved bellied duck decoys have been made for many, many years in both wood, hollowed out wood, and cork in both the Havre De Grace and East Coast style of decoy carving.

Decoys may or may not be weighted, so that they are self-righting in the water. Weighting will be accomplished by any one of many methods, not limited to a metal weight (stainless, steel, zinc, coated metal, lead, etc.) or sand in the base or bottom of the decoy, or use of a heavier material in the bottom portion of the decoy. The decoy weights may be attached by, and is not limited to the following methods of attachment; rivets, adhesive, screws and the like.

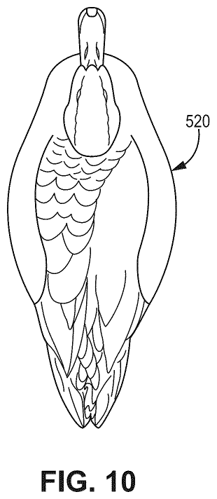

FIG. 10 is a top view of the decoy 520, according still another embodiment. This top view shows the various feather detail with could be painted with Ultraviolet paint or regular paint. Decoys will feature painting to mimic the respective waterfowl species the decoy represents. Waterfowl include an extra set of photoreceptor cones specifically which capture UV radiation. They have increased sensitivity to light and UV light-which results in waterfowl having tetra-chromatic vision. Birds have UV-sensitive (UVS) visual pigments with sensitivity maxima around 360-373 nm (UVS) or 402-426 nm (violet-sensitive, VS). This is particularly useful for waterfowl as the percentage of UV light is highest at dawn and dusk. Accordingly, the sub-scale waterfowl decoys, in one embodiment, will use ultraviolet (“UV”) paint, such as paint tailored to the UV vision capabilities of waterfowl. In this manner, waterfowl will also be able to more easily see the decoys especially at dawn and dusk which can correspond to lots of movement of waterfowl. Of course, it is contemplated that other paints could be used to paint a waterfowl decoy.

Decoys will have at least one fitting to attach a decoy anchor line. Decoys will feature an attachment on the forward and submerged portion of the decoy, so that users of the decoy may attach a connection device such as, and not limited to, a snap swivel. Alternatively, the decoy line may be attached directly to the attachment point.

### DISCUSSION OF POSSIBLE EMBODIMENTS

The following are non-exclusive descriptions of possible embodiments of the present invention.

According to one aspect, a subscale waterfowl decoy device including a subscale body having a length in the range of 0.25 L to 0.85 L, where L is the length of a full-sized waterfowl. The subscale waterfowl decoy including a pair of subscale waterfowl wings attached to the body, a subscale waterfowl head attached to the subscale body.

The device of the preceding paragraph can optionally include, any, one or more of the following features, configurations or additional components. The system/method of the preceding paragraph can optionally include, additionally and/or alternatively any, one or more of the following features/steps, configurations and/or additional components The subscale body can be made of a buoyant material. The subscale waterfowl decoy can include a weight system attached to the waterfowl body. In another embodiment, the subscale waterfowl decoy device wherein the length L of subscale body is in the range of 0.3 L to 0.8 L. In yet another embodiment, the subscale waterfowl decoy device has a subscale body is in the range of 0.35 L to 0.75 L. In another embodiment, the subscale waterfowl decoy device has a subscale body in the range of 0.45 L to 0.75 L. In still a further embodiment, the subscale waterfowl decoy device has a subscale body is in the range of 0.5 L to 0.75 L.

For example, the subscale waterfowl decoy device may have the weight system attached below a waterline of the waterfowl body. In one embodiment the subscale waterfowl body includes an underside and the weight system attached to the underside of the waterfowl body. In yet another embodiment, at least a portion of the weight system is incorporated into the waterfowl body. One way to incorporate the weight system into the body is by injection molding around at least a portion of the weight system.

The weight system further includes a weight, a first finger having a first end attached to the weight, and a first ring attached to the weight. The weight system also includes a second finger having a first end attached to the weight, the second finger including a second ring at the unattached second end of the second finger. The subscale waterfowl decoy device is made of buoyant material, and the waterfowl decoy has a waterline. The weight of the weight system is selected to locate a center of gravity of the waterfowl decoy to a position near the waterline. In one embodiment, the first ring is toward the end of the body where with the subscale head. The first ring is sized to receive an anchor line. In another embodiment, the second ring is located near a tail end of the decoy, wherein both the first ring and the second ring are sized to receive an anchor line.

According to another aspect, a plurality of subscale waterfowl decoy devices grouped together as a set, at least some of the plurality of subscale waterfowl decoy devices have a subscale body having a length in the range of 0.25 L to 0.85 L, where L is the length of a full-sized waterfowl. The subscale waterfowl decoys also have a pair of subscale waterfowl wings attached to the body and a subscale waterfowl head attached to the subscale body.

For example, the plurality of subscale waterfowl decoy devices may have at least a plurality of waterfowl decoys with a subscale body made of a buoyant material. In another embodiment, the plurality of subscale waterfowl decoy devices can include a subscale body having a length in the range of 0.3 L to 0.75 L. In still another embodiment, the plurality of subscale waterfowl decoy devices has different sizes in relation to the length, L, of a full-sized waterfowl.

According to yet another aspect, a kit includes a plurality of subscale waterfowl decoy devices, at least some of the plurality of subscale waterfowl decoy devices having a subscale body having a length in the range of 0.25 L to 0.85 L, where L is the length of a full sized waterfowl, a pair of subscale waterfowl wings attached to the body, and a subscale waterfowl head attached to the subscale body, at least the subscale body made of a buoyant material The subscale waterfowl decoy devices also include a weight system attached to the waterfowl body, an anchor ring positioned on an underside of the waterfowl body, and a set of anchor lines for the plurality of subscale waterfowl decoy devices.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A subscale waterfowl decoy device comprising:
a subscale body having a length in the range of 0.25 L to 0.85 L, where L is the length of a full sized waterfowl;
a pair of subscale waterfowl wings attached to the body;
a subscale waterfowl head attached to the subscale body, at least the subscale body made of a buoyant material; and
a weight system attached to the waterfowl body.

2. The subscale waterfowl decoy device of claim 1 wherein the length L of subscale body is in the range of 0.3 L to 0.8 L.

3. The subscale waterfowl decoy device of claim 1 wherein the length L of subscale body is in the range of 0.35 L to 0.75 L.

4. The subscale waterfowl decoy device of claim 1 wherein the length L of subscale body is in the range of 0.4 L to 0.75 L.

5. The subscale waterfowl decoy device of claim 1 wherein the length L of subscale body is in the range of 0.45 L to 0.75 L.

6. The subscale waterfowl decoy device of claim 1 wherein the length L of subscale body is in the range of 0.5 L to 0.75 L.

7. The subscale waterfowl decoy device of claim 1 wherein the weight system attached below a waterline of the waterfowl body.

8. The subscale waterfowl decoy device of claim 1 wherein the subscale waterfowl body includes an underside, the weight system attached to the underside of the waterfowl body.

9. The subscale waterfowl decoy device of claim 1 wherein at least a portion of the weight system is incorporated into the waterfowl body.

10. The subscale waterfowl decoy device of claim 9 wherein at least a portion of the weight system is incorporated into the waterfowl body by injection molding around at least a portion of the weight system.

11. The subscale waterfowl decoy device of claim 1 wherein the weight system further comprises:
a weight;
a first finger having a first end attached to the weight, the first finger including a first ring at an unattached end of a second finger; and
the second finger having a first end attached to the weight, the second finger including a second ring at the unattached second end of the second finger.

12. The subscale waterfowl decoy device of claim 11 wherein the waterfowl decoy is made of buoyant material, and the waterfowl decoy has a waterline, the weight of the weight system selected to locate a center of gravity of the waterfowl decoy to a position near the waterline.

13. The subscale waterfowl decoy device of claim 11 wherein the first ring is toward the end of the body where with the subscale head.

14. The subscale waterfowl decoy device of claim 11 wherein the first ring is sized to receive an anchor line.

15. The subscale waterfowl decoy device of claim 11 wherein the first ring is toward the end of the body where with the subscale head, and the second ring is located near a tail end of the decoy, wherein both the first ring and the second ring are sized to receive an anchor line.

16. A plurality of subscale waterfowl decoy devices grouped together as a set, at least some of the plurality of subscale waterfowl decoy devices comprising:
a subscale body having a length in the range of 0.25 L to 0.85 L, where L is the length of a full sized waterfowl;
a pair of subscale waterfowl wings attached to the body; and
a subscale waterfowl head attached to the subscale body, at least the subscale body made of a buoyant material.

17. The plurality of subscale waterfowl decoy devices of claim 16 having a subscale body having a length in the range of 0.3 L to 0.75 L.

18. The plurality of subscale waterfowl decoy devices of claim 16 having different sizes in relation to the length, L, of a full-sized waterfowl.

19. A kit comprising:
a plurality of subscale waterfowl decoy devices, at least some of the plurality of subscale waterfowl decoy devices comprising:
a subscale body having a length in the range of 0.25 L to 0.85 L, where L is the length of a full sized waterfowl;
a pair of subscale waterfowl wings attached to the body;
a subscale waterfowl head attached to the subscale body, at least the subscale body made of a buoyant material;
a weight system attached to the waterfowl body;
an anchor ring positioned on an underside of the waterfowl body; and
a set of anchor lines for the plurality of subscale waterfowl decoy devices.
